(19) United States
(12) Patent Application Publication
(10) Pub. No.: US 2008/0294539 A1
(43) Pub. Date: Nov. 27, 2008

(54) PROGRAMMED SYSTEM AND METHOD FOR CONSTRUCTING AN INDEX

(75) Inventors: Gregory Bassuk, Rye Brook, NY (US); David Fogel, Fairfield, CT (US); Adam Patti, Great Neck, NY (US); Arun Singhal, New Rochelle, NY (US)

Correspondence Address: DARBY & DARBY P.C., P.O. BOX 770, Church Street Station, New York, NY, 10008-0770, US

(73) Assignee: IndexIQ Inc., Rye Brook, NY (US)

(21) Appl. No.: 11/751,926

(22) Filed: May 22, 2007

(51) Int. Cl. G06Q 40/00; G06F 17/00

(52) U.S. Cl. 705/35; 705/1

(57) ABSTRACT

Construction of an index of assets comprises a computer having program code executing within a memory of the computer so as to define a universe of eligible companies using one or more filter criteria provided by a user. The companies in the eligible universe are ranked with regard to one or more parameters, each of which represents objective accounting-based data of the respective company. Respective rankings of each company are transformed into respective composite scores. A relative ranking among an index-component subset of the companies in the eligible universe is defined using the each index component's composite score in relation to the composite score of the other index components. In this way, a relative composite score results, which is used to weight the index components. The weighting results are output to the user. A method for such index construction is also disclosed.

### FIELD OF THE INVENTION

The present invention concerns programmed systems and methods for constructing indexes such as can be used in the financial industry.

### BACKGROUND OF THE INVENTION

Conventionally, there are various broad categories of securities portfolio management. One conventional securities portfolio management category is active management wherein the securities are selected for a portfolio individually based on economic, financial, credit, and/or business analysis; on technical trends; on cyclical patterns; etc. Another conventional category is passive management, also called indexing, wherein the securities in a portfolio duplicate those that make up an index. The securities in a passively managed portfolio can be weighted in a conventional manner, such as by relative market capitalization weighting. Another middle ground conventional category of securities portfolio management is called enhanced indexing, in which a portfolio's characteristics, performance and holdings are substantially dominated by the characteristics, performance and holdings of the index, albeit with modest active management departures from the index.

The present invention relates generally to the passive indexing category of portfolio management. A securities market index, by intent, reflects an entire market or a segment of a market. A passive portfolio based on an index may also reflect the entire market or segment. Often every security in an index is held in the passive portfolio. Sometimes statistical modeling is used to create a portfolio that duplicates the profile, risk characteristics, performance characteristics, and securities weightings of an index, without actually owning every security included in the index. (Examples could be portfolios based on the Wilshire 5000 Equity Index or on the Lehman Brothers Aggregate Bond Index). Sometimes statistical modeling is used to create the index itself such that it duplicates the profile, risk characteristics, performance characteristics, and securities weightings of an entire class of securities. (The Lehman Brothers Aggregate Bond Index is an example of this practice).

Indexes are generally all-inclusive of the securities within their defined markets or market segments. In most cases indexes may include each security in the proportion that its market capitalization bears to the total market capitalization of all of the included securities. The only common exceptions to market capitalization weighting are equal weighting of the included securities (for example the Standard & Poors 500 Equal Weighted Stock Index), which includes all of the stocks in the S&P 500 on a list basis; each stock given equal weighting as of a designated day each year) and share price weighting, in which share prices are simply added together and divided by some simple divisor (for example, the Dow Jones Industrial Average). Conventionally, passive portfolios are built based on an index weighted using one of market capitalization weighting, equal weighting, and share price weighting.

Advantages of passive investing include: a low trading cost of maintaining a portfolio that has turnover only when an index is reconstituted, such as once a quarter or once a year; a low management cost of a portfolio that requires no analysis of individual securities; and a reduced chance of the portfolio suffering a greater loss—relative to the market or market segment the index reflects—because of misjudgments in individual securities selection.

Advantages of using market capitalization weighted as the basis for a passive portfolio include that the index (and therefore a portfolio built on it) remains continually ‘in balance’ as market prices for the included securities change, and that the portfolio performance participates in (i.e., reflects) that of the securities market or market segment included in the index.

The disadvantages of market capitalization weighted passive indexes, which can be substantial, center on the fact that any under-valued securities are underweighted in the index and related portfolios, while any over-valued securities are over-weighted. Also, the portfolio based on market capitalization weighting follows every market (or segment) bubble up and every market crash down. Finally, in general, portfolio securities selection is not necessarily based on criteria that reflect a better opportunity for appreciation than that of the market or market segment overall.

U.S. Publication No. 2006/0015433 A1 proposes a non-capitalization weighted fundamental indexing system. The index therein described is constructed so as to have at least one of the index components weighted on a basis other than market capitalization, equal weighting with other components, or share price weighting. The '433 publication proposes weighting the assets in view of any fundamental accounting data that can be found in a standard company annual report. Setting aside whether such a proposal is in fact novel, there remains a need in the art to establish indexes on objective data in which the index components are weighted on the basis of their relative ranking among companies that are generally eligible for inclusion in a given index and their relative ranking among the other components within the index itself. The present invention addresses that deficiency in the art.

### SUMMARY OF THE INVENTION

In one aspect, the invention can be understood as a three-phased methodology. In the first phase, a universe of companies can be selected by applying certain objective universe-eligibility parameters. Such parameters include, without limitation, objective criteria relating to geography (U.S. vs. Global. vs. International vs. Regional vs. Country), industry sectors (all sectors vs. a particular sector such as Financials or Technology), minimum levels of liquidity (e.g., trading volume, stock exchange listing), and size (e.g., large cap, mid cap, small cap). In the second phase, companies within the eligible universe can be compared to one another and ranked with regard to one or more parameters, and more typically two or more parameters, such as objective accounting data or ratios of such data. A selection of so-ranked companies among this group are identified and selected for inclusion as an index component, up to about a total number of companies.

In the third phase, the weighting of each index component can be determined by rankings computed relative to the other index components while at the same time taking into account how each company performed with regard such parameter(s) relative to all other companies in the underlying eligible universe. This is because weighting for each selected company is still based on its ranking (i.e., its “composite score”) computed with regard to the company's performance relative to the universe of eligible companies.

In accordance with one salient aspect of the invention, a method for constructing an index having index components is described. The method operates within a computer executing software including the steps of defining within a memory of the computer a universe of eligible companies using one or more filter criteria provided by a user, ranking the companies in the eligible universe with regard to one or more parameters, each parameter concerning objective accounting-based data of a respective company, transforming the respective rankings of each company in the eligible universe into a composite score for each company, defining a relative ranking among a subset of the companies in the eligible universe that are to comprise the index components, wherein the defining step uses the composite score of each of the index components in relation to the composite score of the remainder of the index components to arrive at a relative composite score (RCS), and weighting the index components in accordance with the RCS.

In further aspects, such a method can have the defining step including the additional steps of summing the composite scores of the index components and computing the RCS for each index component as the sum of the composite scores divided by each respective composite score. Optionally, the weighting step can include summing the respective RCSs of all of the index components and dividing each respective RCS by the sum.

In accordance with another salient aspect of the invention, a system for constructing an index of assets comprises a computer having a processor, a memory and an output, a monitor connected to the computer and operative to display information output by the computer, and program code executing within the processor. The program code and performing the steps of defining within the memory a universe of eligible companies using one or more filter criteria provided by a user, ranking the companies in the eligible universe with regard to one or more parameters, each parameter concerning objective accounting-based data of a respective company, transforming the respective rankings of each company in the eligible universe into a composite score for each company, defining a relative ranking among a subset of the companies in the eligible universe that are to comprise the index components, wherein the defining step uses the composite score of each of the index components in relation to the composite score of the remainder of the index components to arrive at a relative composite score (RCS), weighting the index components in accordance with the RCS, and outputting the weighting results to the monitor.

These and other aspects, features and advantages of the invention will be apparent from a review of the accompanying drawing figures and description of certain embodiments of the invention.

### BRIEF DESCRIPTION OF THE DRAWING FIGURES

FIG. 1 is a flow diagram illustrating the ranking of companies for selection as index components;

FIG. 2 is a table showing the relative performance of a set of companies within an “eligible universe” of companies with respect to each of several performance parameters;

FIG. 3A is the eligible universe of FIG. 2, now sorted by composite scores which have been computed with regard to an even weighting of performance parameters A, B and C;

FIG. 3B is a table showing the weighting computations for the top-rated companies of FIG. 3A which have been selected as components for inclusion in index ABC;

FIG. 4A is the eligible universe of FIG. 2, now sorted by composite scores which have been computed with regard to an even weighting of performance parameters C, D and E;

FIG. 4B is a table showing the weighting computations for the top-rated companies of FIG. 4A which have been selected as components for inclusion in index CDE;

FIG. 5A is the eligible universe of FIG. 2, now sorted by composite scores which have been computed with regard to an uneven weighting of performance parameters A, B and C;

FIG. 5B is a table showing the weighting computations for the top-rated companies of FIG. 5A which have been selected as components for inclusion in index 2ABC;

FIG. 6 is a flow diagram illustrating the weighting of the companies that comprise the index components of an index;

FIG. 7 is a deployment diagram showing apparatus arranged for index generation and use in order to implement certain aspects of the present invention; and

FIG. 8 is a process flow diagram showing an index use process that can be used in accordance with certain optional aspects of the invention.

### DETAILED DESCRIPTION OF CERTAIN EMBODIMENTS

By way of overview and introduction, a methodology constructs an index by weighting companies based on how each index component performs with respect to various parameters relative to all companies in the eligible universe and also relative to the other index components. In this way, an index is defined in which the highest performers can be selected from a relevant set of companies, with the weighting of the resulting index established on the basis of the comparative standing of each of these “highest performers” relative to the other selected companies. An index can be automatically defined in this manner, and can be so-defined without subjective influence.

Once an index is generated, the index can be used to track the business sector defined by the metric or to create a portfolio of assets offered by the entities whose information was used to generate the index. The portfolio of assets can include, for example, a fund; a mutual fund; a fund of funds; an asset account; an exchange-traded fund (ETF); a separate account, a pooled trust; a limited partnership, or a combination of any of these or other assets.

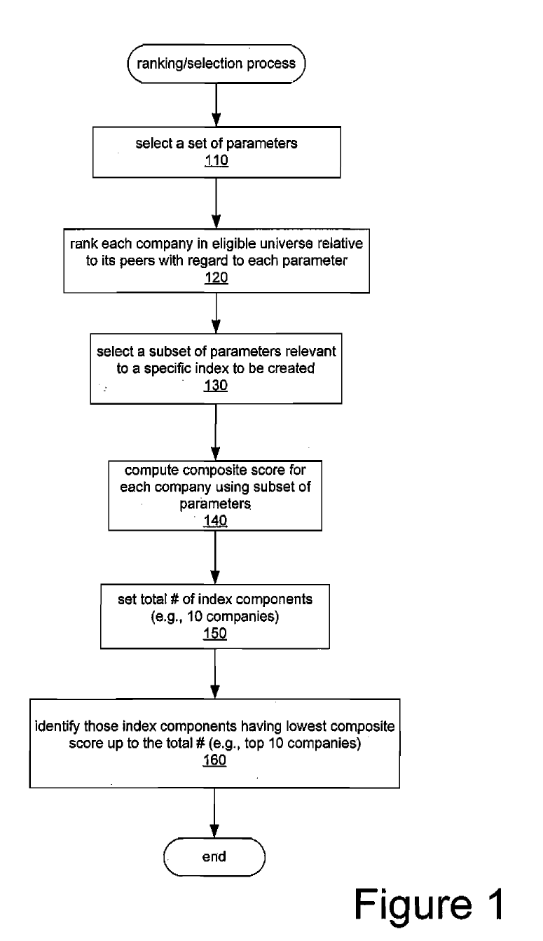

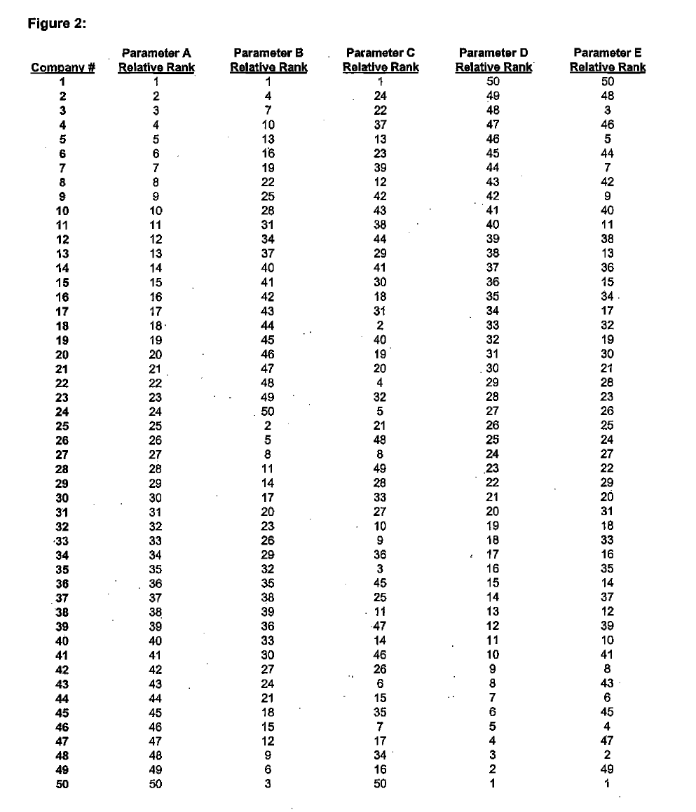

The process of including companies into an index is outlined in FIG. 1 and is discussed by way of example in conjunction with an exemplary universe of eligible companies shown in FIG. 2. A universe of eligible companies can include a great number of companies. FIG. 2 schematically identifies 50 companies in a universe of companies eligible for selection and inclusion in a particular index. The members of the eligible universe are identified by imposing a set of constraints on qualification for inclusion in the universe. Some constraints can be qualitative, such as sector (domestic, international, energy, financial institution, etc.) Other constraints can be quantitative, such as minimum amount of liquidity or market capitalization. The constraints can include other factors that enable a determination as to whether a particular candidate company is to be included within or excluded from the eligible universe, on an objective basis. As such, the constraints comprise filter criteria which influence which companies are included within the eligible universe. A computer accesses standard data sources to filter companies and thereby define the eligible universe in accordance with the filter criteria.

At block 110, a set of parameters that are to be considered in the selection of index components for the eligible universe is identified. The parameters to be considered are selectable in accordance with good business judgment and practice and generally comprise objective accounting-based data. For a given index, therefore, the parameters selectable in accordance with good business judgment might include, but are not limited to, any combination of: revenue, profitability, sales, total sales, foreign sales, domestic sales, net sales, gross sales, profit margin, economic value of an investment or project (e.g., the net operating profit after taxes minus the product of capital times the cost of capital), use of capital, operating margin, retained earnings, earnings per share, book value, book value adjusted for inflation, book value adjusted for replacement cost, book value adjusted for liquidation value, dividends, assets, tangible assets, intangible assets, fixed assets, property, plant, equipment, goodwill, replacement value of assets, liquidation value of assets, liabilities, long term liabilities, short term liabilities, net worth, research and development expense, accounts receivable, earnings before interest, taxes, dividends, and amortization (EBITDA), accounts payable, cost of goods sold (CGS), debt ratio, budget, capital budget, cash budget, direct labor budget, factory overhead budget, operating budget, sales budget, inventory method, type of stock offered, liquidity, book income, tax income, capitalization of earnings, capitalization of goodwill, capitalization of interest, capitalization of revenue, capital spending, cash, compensation, employee turnover, overhead costs, credit rating, growth rate, tax rate, liquidation value of company, capitalization of cash, capitalization of earnings, capitalization of revenue, cash flow, future value of expected cash flow, gross margin, momentum in quarterly sales, total assets, sales per share, debt service ratio, economic profit, enterprise value, free cash flow, inventory, inventory turnover, average inventory, tangible book value, net intangibles, net assets, total number of employees, net operating income, price volume, and/or receivables turnover.

The parameters that can be used can also include a ratio of any combination of objective parameters. For example, the ratio can be the current ratio, debt ratio, overhead expense as a percent of sales, or debt service burden ratio. The parameters also can include fundamentals such as: the relative size of a company's profits, or its pre exceptional profits, or sales, or return on investment, or a ratio of any of the foregoing.

As will be appreciated by persons of ordinary skill in the art, the particular parameters to be used can be varied widely, and hereafter are referred to as being parameters A, B, C, etc.

Each of the companies will have a respective value associated with it for each of the selected parameters. The actual values for each parameter implicitly rank one company in the eligible universe as compared to the others, but can be sorted to identify the relative ranking of all of the companies in comparison to their peers in the eligible universe. For example, they can be ranked from highest to lowest (descending order) or lowest to highest (ascending order), as applicable. The rank is recorded, as indicated at block 120. The relative rank of that company within the eligible universe becomes a basis for computing a composite score of that company to its peers, as discussed below. As a non-limiting example, if parameter A is net income, and the index methodology is developed to include companies with strong financial results, the methodology would rank the net income parameter in terms of highest (best company) to lowest (worst company) net income. Using that same example, the debt parameter would be ranked in terms of lowest (best company) to highest (worst company). As another example made with reference to FIGS. 1 and 2, if parameter A were to correspond to EBITDA, then the company among the fifty in the eligible universe of FIG. 2 having the highest earnings before interest and tax (company #1) would have a relative rank of “1.” If parameter E were to correspond to liabilities, then FIG. 1 shows that company #1 has the lowest rank relative to that parameter whereas company #3 by relative comparison has comparable EBITDA but substantially lower liability (company #3 is ranked third place with regard to both parameters).

The value of the parameters computed for companies in the eligible universe can be used to exclude eligible index components rather than to include components. By way of example, if an index is developed to include companies that exhibit the strongest financial results using parameters such as from the list above, the methodology can utilize any earnings restatement parameter (i.e., an indicator of poor performance) that results in the exclusion of eligible-universe companies from the index on the basis of the frequency and/or consistency of earnings restatements over a given period of time.

The relative rank assigned to each company's performance with regard to each parameter under consideration results in data such as illustrated in the Table of FIG. 2. This information can be arranged in a variety of ways within a memory of a machine executing instructions that perform the process steps of FIG. 1, including as non-limiting examples, as an array, a linked list, or as database entries.

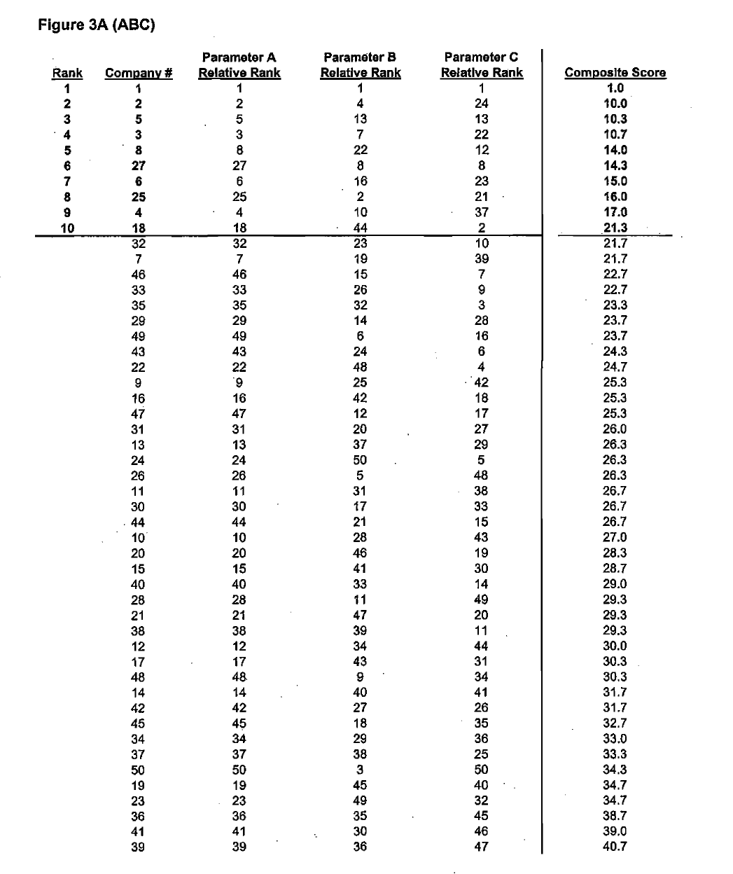

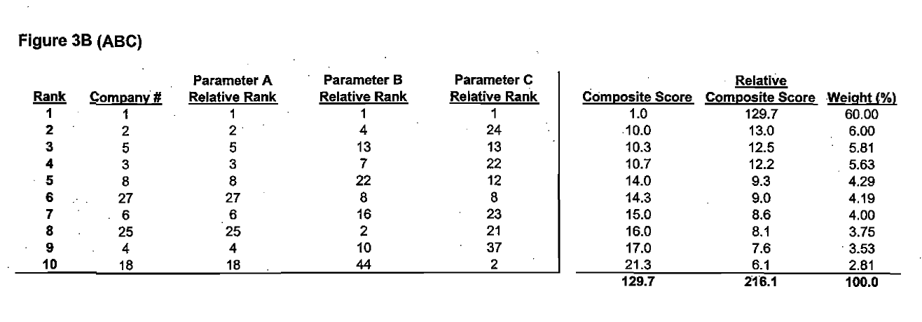

The set of parameters that are under consideration with regard to the eligible universe of companies can be more inclusive than required to construct any particular index. In other words, certain parameters and the associated relative rankings of the eligible universe companies need not be taken into consideration in constructing a particular index. Instead, a subset of parameters can be selected as the relevant parameters for a particular index, as indicated at block 130 and as shown in FIG. 3A. On the other hand, the parameters under consideration can comprise the full set of data that is gathered and used to compute a composite score, and no action need be taken at block 130 (i.e., the “subset” of parameters is the same as the set of parameters in that case). For instance, the data collected for purposes of computing relative ranks of companies for the parameters A, B, and C can include only those three parameters. Thus, a method can be implemented in which the subset of parameters is selected before the companies are ranked, and the ranking can be with regard to just that subset.

The discrete parameters under consideration are transformed into a composite score. The composite score is determined for each company in the eligible universe using an average of its relative rank for all of the parameters under consideration. In one mode of constructing an index, the parameters are weighted equally such that each parameter contributes equally to the composite score. In other modes, as discussed below, one parameter can be given a different weight in the composite score than others. More generally, however, a composite score is computed for each company using the relevant set/subset of parameters, as indicated at block 140. For example, FIG. 3A shows index ABC in the midst of the ranking and selection process. Index ABC is constructed by considering the relative rank of companies in the eligible universe with regard to each of parameters A, B and C on an even-weighted basis. Thus, the composite score for each entry in ABC is computed by summing the relative ranks of parameters A, B and C, and dividing that sum by three. The right column shows the so-computed composite score.

Preferably, the user who is controlling the program that is constructing the index is presented with the data sorted as shown in FIG. 3A. For example, the user can be an analyst using analysis software having access to entity data about various entities that have assets that are traded. For example, publicly traded companies must disclose information about certain financial aspects of their operations. This information can be aggregated for a plurality of entities. Market sectors and corresponding indexes may then be identified and generated using the aggregate data. This data can be gathered and made available to the analysis software over a network of machines, in a conventional manner, such as a real-time data feed from a standard market-data source.

The companies in the eligible universe and their relative rankings for each parameter are presented in the order of best composite score (here, the lowest score) to worst. Company #1 has a relative rank to its peers of “1” for each of parameters A, B and C and so the simple average computation of the composite score for company #1 is 1.0. Company #2 had relative ranks of 2, 4, and 24 for parameters A, B, and C, respectively, and so the simple average computation of the composite score for company #2 is 10.0. The composite score computations are performed for each company in the eligible universe, and the results can be sorted for presentation to the user, if desired.

It should be understood that the relative rank can vary as a function of asset class. The same company can have a different relative ranking depending on the parameters under consideration and the asset class. Asset types include but are not limited to, stocks, commodities, futures contracts, bonds, mutual funds, hedge funds, funds of funds, ETFs, and derivatives.

At block 150, or optionally earlier in the process, the user controlling the program establishes a total number of components (companies) that are to be included in the index under construction. The total number need not be rigidly imposed, however. The total can be a benchmark (“let's construct an index of 50 companies”), with the actual selection of components varying upwards or downwards from the benchmark based on closeness of composite scores. Thus, for example, if the composite scores for the companies that would be the 48^{th}, 49^{th}, 50^{th} and 51^{st} companies in the index are about the same, then the index might be constructed with 51 companies. The point here is that the total number is not an absolute constraint, but rather is a guideline. Typically, an index can include on the order of a hundred companies as indexes are generally targeted to be representative of an investment category (e.g., the electric utility sector). For ease of illustration, however, the indexes described herein include the top ten companies that have been identified and then separated from the remainder of the companies in the eligible universe. These ten companies are then included in the index as index components, with a weighting as described below.

At block 160, the index components are identified (and selected) as those companies having the best composite scores within the total number of index components that are to be included. As noted, the total number of index components for purposes of this description is ten, but persons of ordinary skill in the art will appreciate that any number of index components can constitute any particular index, and typically the number of components will be 50, 75, 100 or more.

Referring now to FIGS. 3A and 3B, the ten index components for index ABC are shown with their respective rank in the left column. The composite score that resulted in their respective rank is also illustrated. This information is managed within the memory of the machine executing the program code that is being used to construct index ABC. Instructions operate on this data to result in the composite score and the further computations discussed next. The index components are objectively identified on the basis of the relative ranking of the parameters under consideration with respect to all companies in the relevant eligible universe. The two-tiered approach to selecting index components can be appreciated by comparing the information in FIGS. 3A and 3B. In FIG. 3A the company ranked No. 10 is Company #18, and despite having a relative ranking of parameters A and B of 18 and 44, respectively, out of a universe of 50 companies, this company is included as an index component because it had a relative rank of 2 out of 50 for parameter C such that the composite score for Company #18 averaged over Parameters A, B and C is sufficiently good to be included in Index ABC.

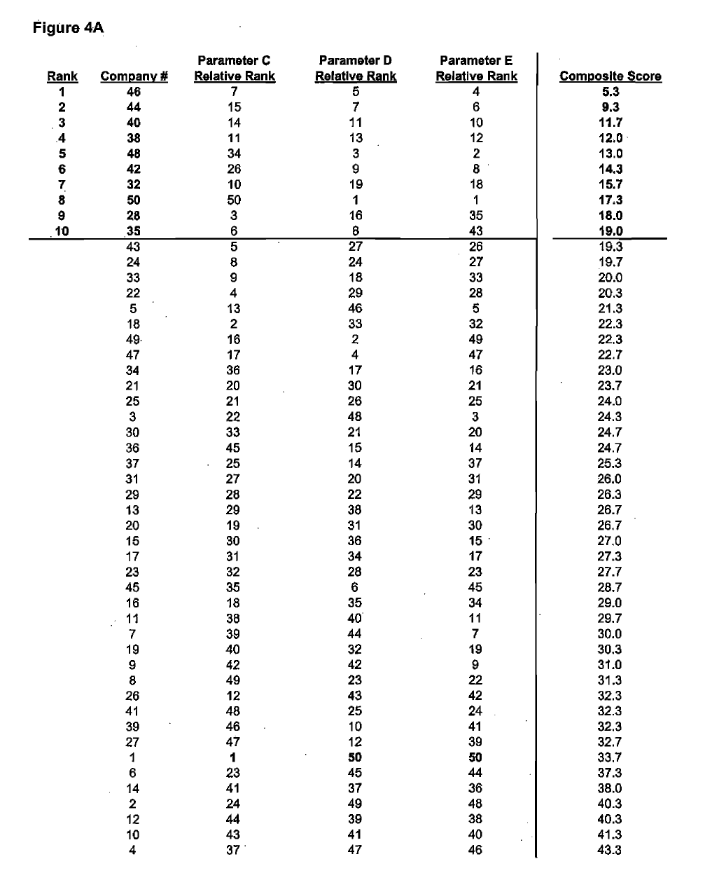

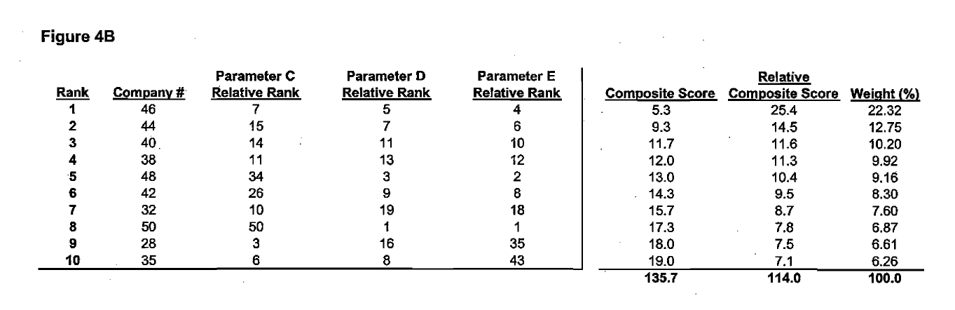

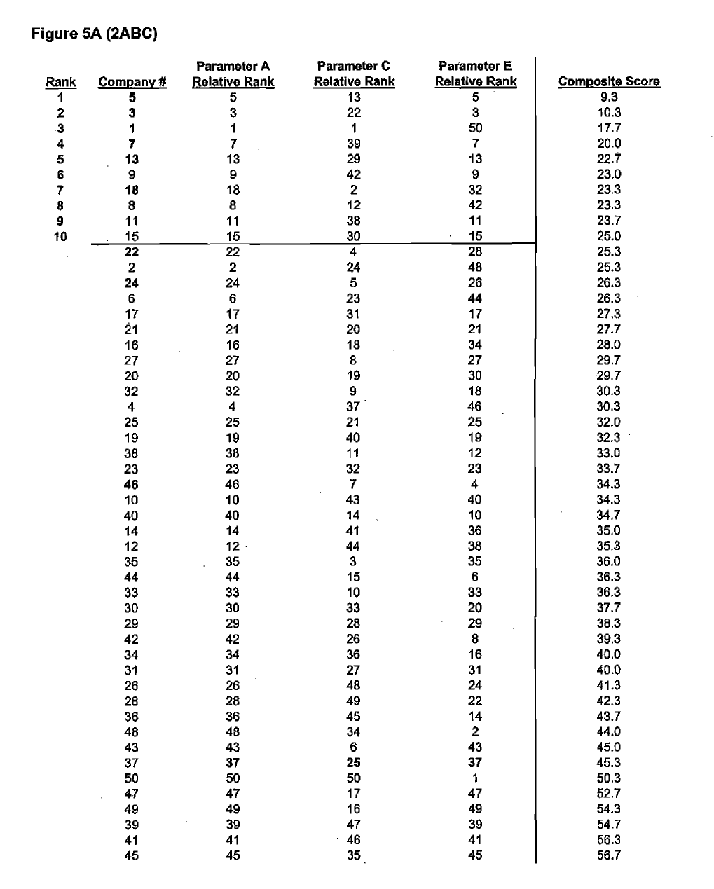

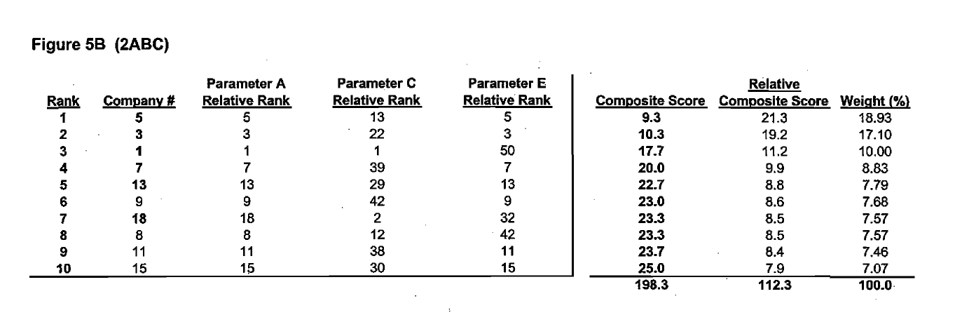

Turning briefly to FIG. 4A, a second subset of parameters extracted from the group shown in FIG. 2 can be used to create an index CDE, using parameters C, D and E. The component ranking and selection process is otherwise as described above. In FIG. 5A, parameters A, B and C are again used to create an index, index 2ABC, but the index 2ABC differs from the index of FIG. 3A by having an uneven weighting assigned to the parameters. Index 2ABC imparts a 2× multiplier on the relative ranking of parameter A, which influences the composite score calculation and hence the identification and selection of companies that comprise the components of index 2ABC differ than those of index ABC.

FIGS. 3A, 4A and 5A provide a useful illustration of how varying results can occur within the same universe of eligible companies. For instance, there is no overlap among the companies that comprise index ABC (FIG. 3A) and index CDE (FIG. 4A), yet both two indexes include parameter C in common with each other, and parameter C constitutes one-third of the composite score calculation used in selecting the components of each index. With further regard to parameter C, the relative rank of the top two companies are included in index ABC, whereas the next highest rank (company #28) is excluded from index ABC (because company #28 did not have a sufficiently good composite score for that index) and is included in index CDE. As another illustration, company #1 is included in index ACE despite being ranked last (50^{th}) in one of the three parameters under consideration for that index, whereas company #50 is included in index CDE even though it is ranked last (50^{th}) in one of the three parameters. This reinforces that it is the combination of multiple factors, each of which is equally and objectively applied, which yields the index components.

The ranking and index-component selection process of FIG. 1 has companies within the eligible universe compared against one another to arrive at a composite score, and that score determines which companies are to be included in a given index, such as the ABC index discussed above. The construction of the index itself, however, requires each index component to be represented in the index in a defined proportion.

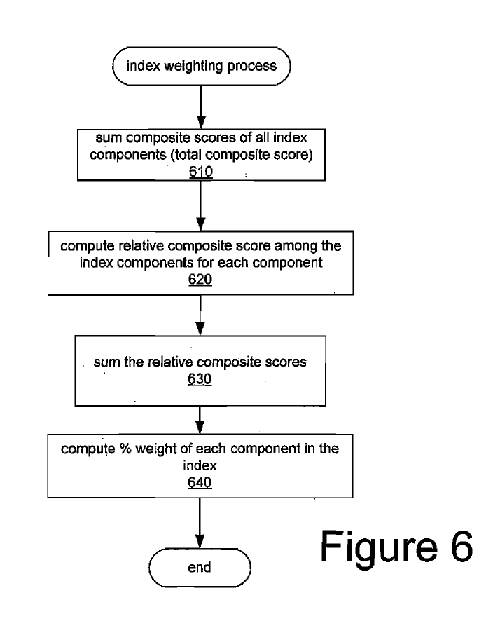

Referring now to FIGS. 3B and 6, the selected index components (companies) have their composite scores processed to arrive at a weighting in the index itself. At block 610, the composite scores of the index components are summed to define a total composite score. In the examples of FIGS. 3B, 4B and 5B, the total composite scores for the exemplary indexes are 129.7, 135.7 and 198.3, respectively. A relative composite score is computed at block 620 to rank the relative score of each component to its peers within the index. Thus, the total composite score can be divided by each index component's respective composite score as one manner of computing the relative composite score of each component (relative to the other components in the index). At block 630, the relative composite scores are summed to define a total relative composite score useful in computing a percentage weight for each component in the index, as done at block 640. In the examples of FIGS. 3B, 4B and 5B, the total relative composite scores for the exemplary indexes are 216.1, 114.0, and 112.3, respectively. The relative composite score for each company is transformed into a weighted percentage of the index by dividing each the relative composite score by the total relative composite score and then multiplying by 100. The relative weights for each of the components totals 100%, as can be seen from the examples. As a result of these steps, each index component is accorded a relative weight in the index. In the index ABC shown in FIG. 3B, company #1 is a dominant component, and this weighting is a mathematical result of its superior ranking to the other companies in the index as well as the underlying eligible universe of companies with respect to each of parameters A, B and C. Also in FIG. 3B, companies #8 and #27 are close in weightings in the index because their respective composite scores are close. Persons of ordinary skill in the art will appreciate that the computations can be carried out with higher precision using several decimal places.

From the foregoing, it can be appreciated that a relative composite score for each company and a respective weight in the index are determined with regard to the performance of each index component relative to the other index components and also with regard to the performance of each company relative to the other companies in the entire eligible universe. In other words, the index weighting process of FIG. 6 defines the weighting of each component within the index itself, but does so with regard to the relative rank of that index component among its peers in the underlying eligible universe. This is due to the composite score of each index component influencing whether the company is to be included in the index in the first place and also influencing the computation of the weighting in the index relative to the composite scores of the other selected index components. A relative composite score can be computed in other ways using the analysis software, but to be consistent with the broad teachings of the present invention, such computation is to be on an objective basis that includes consideration of each index component's respective composite score.

It can also be appreciated that the weighting of each company within the index is objectively determined, and determinable by the analysis software. A given company's composite score is relevant throughout the index creation process, first in determining whether the company will be included in the index at all and then in determining the company's weight within the index. As for the weighting portion, a company's composite score is used relative to all companies in the eligible universe even though the index components have already been selected. This is a departure from other paradigms for weighting indexes, and is a particular improvement in the art as it enables automated determinations of weightings once the parameters of interest have been identified.

The weighting determination for a company in a given index is always a function of how well the company performed on the various parameters under consideration, i.e., its composite score, compared to all other companies in the eligible universe. For example, a top ranked company in one index would have a weighting very similar to the other index components if the composite scores of the components were relatively close together. This is the case for index CDE in FIG. 4B in which the composite scores range from 5.3 to 19.0 and the relative weights similarly are fairly compact. In contrast, the results are quite different for index ABC (FIG. 3B) in which the overall range of composite scores is from 1.0 to 21.3 and, even more strikingly, the differential in composite scores between the highest weighted company and the second-highest weighted company is high. This results in distinct relative weights as between these two index components (a 10× difference in composite scores results in a 10× difference in weights).

It will also be appreciated that the foregoing describes simple average calculations by weighting all parameters equally. Thus, the process can be agnostic as to the individual parameters. The composite score is calculated in a purely objective manner and in the same way for each index, regardless of the fact that one index may use entirely different factors than another product. This differs from traditional stock selection whereby generally more subjective determinations are made by the portfolio manager and particular factors typically are weighted more heavily than others. If desired, an uneven weighting can be assigned to the parameters as done for index 2ABC of FIGS. 5A and 5B.

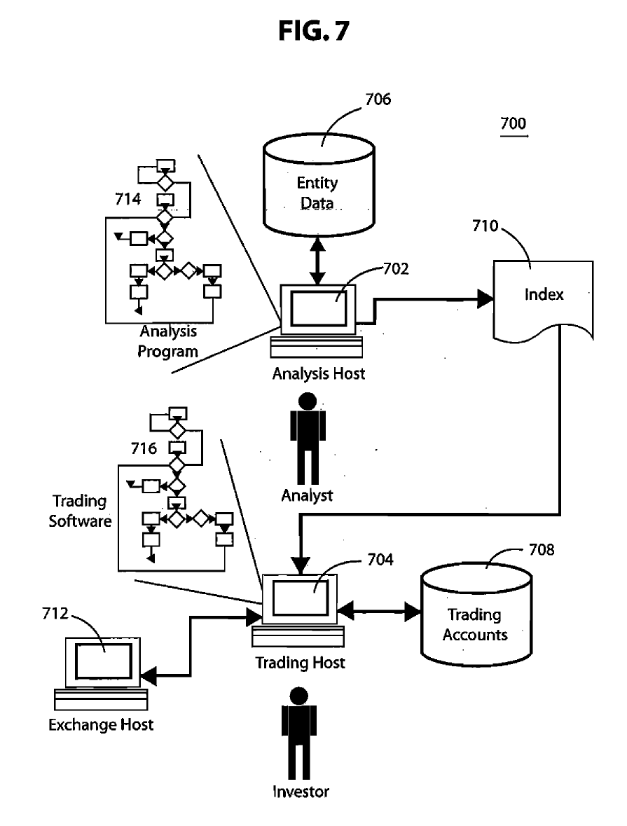

FIG. 7 depicts a deployment diagram 700 of an index generation and use process that can be used in the practice of the invention. An analyst can use a computer system 702 to generate an index 710. The analyst can do so by using analysis software 714 to examine data 706 about entities offering different kinds of financial objects that may be traded by investors. An example of an entity that may be offering financial objects is a publicly held company whose shares trade on an exchange. However, the present invention also applies to any entity that has any type of financial object that is traded, in which information about the entity and/or its financial objects is available for analysis.

Once an index has been generated by an analyst using the entity data 706 and the program code described above, index 710 can be used to build investment portfolios. An investor, advisor, manager or broker can manage any purchased financial objects as a mutual fund, an electronic traded fund, a hedge fund or other portfolio or account of assets for one or for a plurality of individual and/or institutional investors. The investor, advisor, manager or broker can use a trading computer 704 with trading software 716 of conventional construction to manage one or more trading accounts 708. Alternatively, the purchased financial objects can be managed for one or more investors. In the latter case, financial objects can be purchased to match the index within a prescribed tolerance for inclusion in an individual or an institutional investor's portfolio. One or more trades can be made in cooperation with and via communication with an exchange host 712.

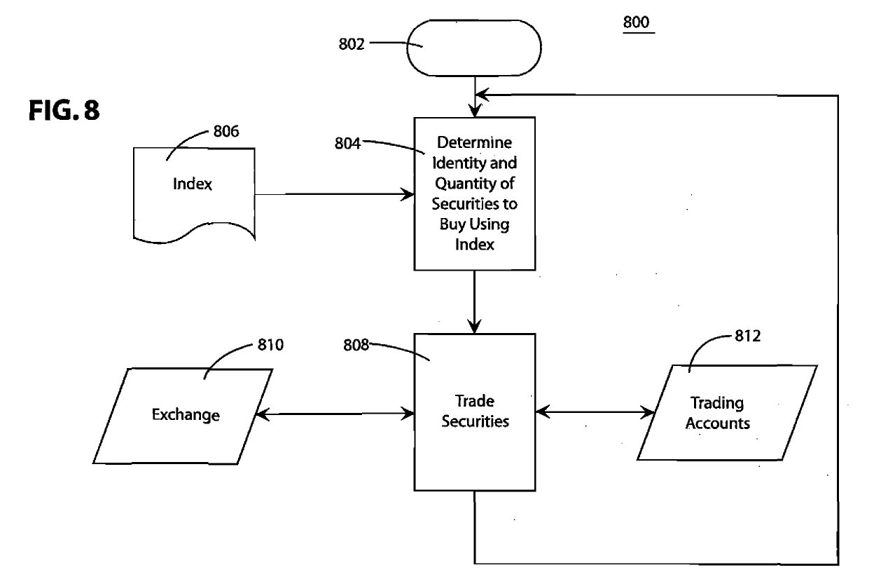

FIG. 8 depicts a flow diagram 800 concerning use of an index in accordance with an optional, further aspect of the present invention. The process starts at block 802. An index 710 as described above can be used to determine the identity and quantity of assets to purchase for a portfolio at block 804. An index can be obtained as a result of the index generation processes of FIGS. 1 and 6 and can be used to determine the identity and quantity of assets to purchase for a portfolio. The assets may be purchased in block 806 from an exchange 814 or other market and may be held on account for an investor or group of investors in trading accounts 808. The index 810 can be updated on, e.g., but not limited to, a periodic basis and may be used as a basis to rebalance the portfolio. The portfolio can be rebalanced when, e.g., a pre-determined threshold is reached instead of or in addition to any periodic rebalancing. In this way, a portfolio may be created and maintained based on an objective, relative-ranked basis which is amenable to automated, rule-driven execution by the analysis software. In other words, if the value of one or more of the underlying performance metrics (parameters) that are used to compute the composite score of an index component changes, then its weighting, or even its continued presence in the index, can be determined programmatically and acted upon without user intervention.

Rebalancing can be based on assets reaching a threshold condition or value. For example, but not limited to, rebalancing may occur upon reaching a threshold such as, e.g., ‘when the portfolio of assets increases in market value by 20%,’ or ‘when the assets on a sub-category within the portfolio exceed 32% of the size of the portfolio,’ or ‘when a U.S. President is elected from a different party than the incumbent,’ etc.

The invention can be implemented on a computing device(s), processor(s), computer(s) and/or communications device(s) of conventional design.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform or operate upon (e.g., filter, sort or otherwise process) that electronic data into other electronic data that may be stored in registers and/or memory.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the recitations in the claims that follow and equivalents to the features and steps recited in such recitations. While this invention has been particularly described and illustrated with reference to certain embodiments, it will be understood to those having ordinary skill in the art that changes in the above description or illustrations may be made with respect to formal detail without departing from the spirit and scope of the invention which is defined exclusively with regard to the claim recitations set forth below and respective equivalent structures and steps.

We claim:

1. A method for constructing an index having index components within a computer executing software that comprises the steps of:
(a) defining within a memory of the computer a universe of eligible companies using one or more filter criteria provided by a user;
(b) ranking the companies in the eligible universe with regard to at one or more parameters, each parameter concerning objective accounting-based data of a respective company;
(c) transforming the respective rankings of each company in the eligible universe into a composite score for each company;
(d) defining a relative ranking among a subset of the companies in the eligible universe that are to comprise the index components, wherein the defining step uses the composite score of each of the index components in relation to the composite score of the remainder of the index components to arrive at a relative composite score (RCS); and
(e) weighting the index components in accordance with the RCS.

2. The method of claim 1, including the additional step of identifying the subset of the companies in the eligible universe to include those companies having the lowest composite scores up to about a total number of index components.

3. The method of claim 2, including the additional step of sorting the composite scores in ascending or descending order, wherein the identifying step includes as the index components the companies in the sorted data up to about the total number of index components.

4. The method of claim 1, wherein the defining step includes the additional steps of summing the composite scores of the index components and computing the RCS for each index component as the sum of the composite scores divided by each respective composite score.

5. The method of claim 4, wherein the weighting step comprises summing the respective RCSs of all of the index components and dividing each respective RCS by the sum.

6. The method of claim 5, including the additional step of multiplying the product of the RCS summing and dividing steps by 100 to compute a weighting percentage for each index component.

7. A system for constructing an index of assets, comprising:
a computer having a processor, a memory and an output;
a monitor connected to the computer and operative to display information output by the computer;
program code executing within the processor and performing the steps of:
(a) defining within the memory a universe of eligible companies using one or more filter criteria provided by a user;
(b) ranking the companies in the eligible universe with regard to one or more parameters, each parameter concerning objective accounting-based data of a respective company;
(c) transforming the respective rankings of each company in the eligible universe into a composite score for each company;
(d) defining a relative ranking among a subset of the companies in the eligible universe that are to comprise the index components, wherein the defining step uses the composite score of each of the index components in relation to the composite score of the remainder of the index components to arrive at a relative composite score (RCS);
(e) weighting the index components in accordance with the RCS; and
(f) outputting the weighting results to the monitor.

8. The system of claim 7, wherein the computer further comprises a network connection, wherein the output is farther coupled to the network connection to convey the weighting results to a remote machine.
